(19) United States
(12) Patent Application Publication
(10) Pub. No.: US 2007/0238421 A1
(43) Pub. Date: Oct. 11, 2007

(54) Transmitter architecture

(76) Inventors: Aslamali A. Rafi, Austin, TX (US); George Tyson Tuttle, Austin, TX (US); Lawrence Der, Austin, TX (US)

Correspondence Address: TROP PRUNER & HU, PC, 1616 S. VOSS ROAD, SUITE 750, HOUSTON, TX, 77057-2631, US

(21) Appl. No.: 11/394,716

(22) Filed: Mar. 31, 2006

(51) Int. Cl. H04B 1/04; H01Q 11/12

(52) U.S. Cl. 455/110; 455/118

(57) ABSTRACT

A technique includes digitally generating orthogonal modulated signals, each of which has spectral energy that is generally centered at an intermediate frequency. The orthogonal modulated signals are frequency translated to produce translated signals, each of which has spectral energy that is generally centered about a second frequency that is higher than the intermediate frequency. The translated signals are combined to generate a modulated signal.

### BACKGROUND

The invention generally relates to a transmitter architecture.

Modulated signals typically are used in the communication of date, such as in the communication of data, across a wireless path. A modulated signal may be formed by changing, or modulating, a property of a sinusoidal carrier signal to reflect the information that is being communicated. The property that is modulated may be an amplitude (for amplitude modulation (AM)), phase (for phase modulation (PM)) or frequency (for frequency modulation (FM)), as examples.

A voltage controlled oscillator (VCO) may be used for purposes of generating an FM signal. In general, the VCO generates a sinusoidal output signal, the frequency of which is a function of a control voltage that is received at a control terminal of the VCO. In the absence of the control voltage, the VCO's output signal is essentially a sinusoidal signal that has a single fundamental frequency. However, applying a time-varying message signal (called “m(t)”) to the control terminal of the VCO causes the frequency of the VCO's output signal to deviate from its fundamental frequency and become an FM signal with its fundamental frequency being the carrier frequency. The FM signal may be mathematically represented as follows:
A_{c} cos(ω_{c}t+∫2πK_{f}m(t)dt), Eq. 1
where “ω_{c}” is the radian carrier frequency, “K_{f}” is the frequency gain and “A_{c}” is the amplitude of the FM signal.

Several challenges may exist in using a VCO to generate an FM signal. For example, the K_{f} frequency gain, which is set by the VCO, may be temperature sensitive and may be dependent on the process that is used to fabricate the VCO. Furthermore, the K_{f} frequency gain may be non-linear, which may lead to audio distortion. Additionally, the VCO's analog varactor, a typical component of the VCO to realize the voltage-to-frequency conversion, may consume a considerable amount of die area.

Thus, there exists a continuing need for better ways to generate an FM signal.

### SUMMARY

In an embodiment of the invention, a technique includes digitally generating orthogonal modulated signals, each of which has spectral energy that is generally centered at an intermediate frequency. The orthogonal modulated signals are frequency translated to produce translated signals, each of which has spectral energy that is generally centered about a second frequency that is higher than the intermediate frequency. The translated signals are combined to generate a modulated signal.

In another embodiment of the invention, a transmitter includes a digital signal processor, mixers and an adder. The digital signal processor generates orthogonal modulated signals, each of which has spectral energy that is generally centered at an intermediate frequency. The mixers frequency translate the orthogonal modulated signals to generate translated signals, each of which has spectral energy that is generally centered about a second frequency that is higher than the intermediate frequency. The adder combines the translated frequency signals to generate a modulated signal.

In yet another embodiment of the invention, a transmitter includes a processor and an upconverter. The processor digitally generates at least one intermediate frequency, modulated signal. The upconverter converts each of the intermediate frequency, modulated signal(s) to a higher frequency.

Advantages and other features of the invention will become apparent from the following drawing, description and claims.

### BRIEF DESCRIPTION OF THE DRAWING

FIG. 1 is a schematic diagram of an FM transmitter.

FIG. 2 is a schematic diagram of an FM transmitter according to an embodiment of the invention.

FIGS. 3, 4, 5, 6, 7 and 8 are spectral energy versus frequency plots to illustrate operation of the FM transmitter of FIG. 2 according to an embodiment of the invention.

FIG. 9 is a flow diagram of a technique to generate an FM signal according to an embodiment of the invention.

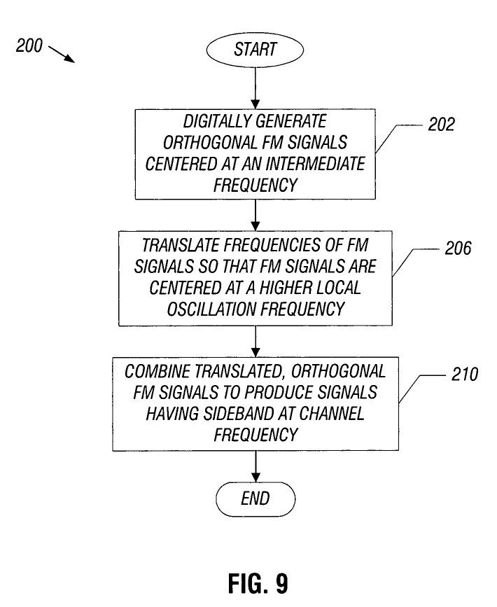

FIG. 10 is a schematic diagram of a multimode transceiver according to an embodiment of the invention.

FIG. 11 is a schematic diagram of a portable wireless device and associated wireless system according to an embodiment of the invention.

### DETAILED DESCRIPTION

In accordance with embodiments of the invention that are described herein, frequency modulation (FM) is performed in the digital domain, which eliminates problems that may be associated with the K_{f} frequency gain, such as the potential non-linearity and process dependency problems. Because FM signals for wireless communications are in the RF or higher frequency ranges, the direct digital generation of these FM signals may be very challenging. Therefore, in accordance with embodiments of the invention that are described herein, relatively low frequency (as compared to RF) FM signals are first digitally generated, and these lower frequency FM signals are then translated (by analog mixers, for example) to higher frequencies.

In accordance with this overall approach, one way to generate an RF FM signal is to digitally generate orthogonal FM signals that have zero carrier frequencies; translate the zero carrier frequency orthogonal FM signals to the RF range; and then combine the translated FM signals to produce the RF FM signal. In the context of this application, “RF” means a frequency in the general range of three kilohertz to hundreds of megahertz.

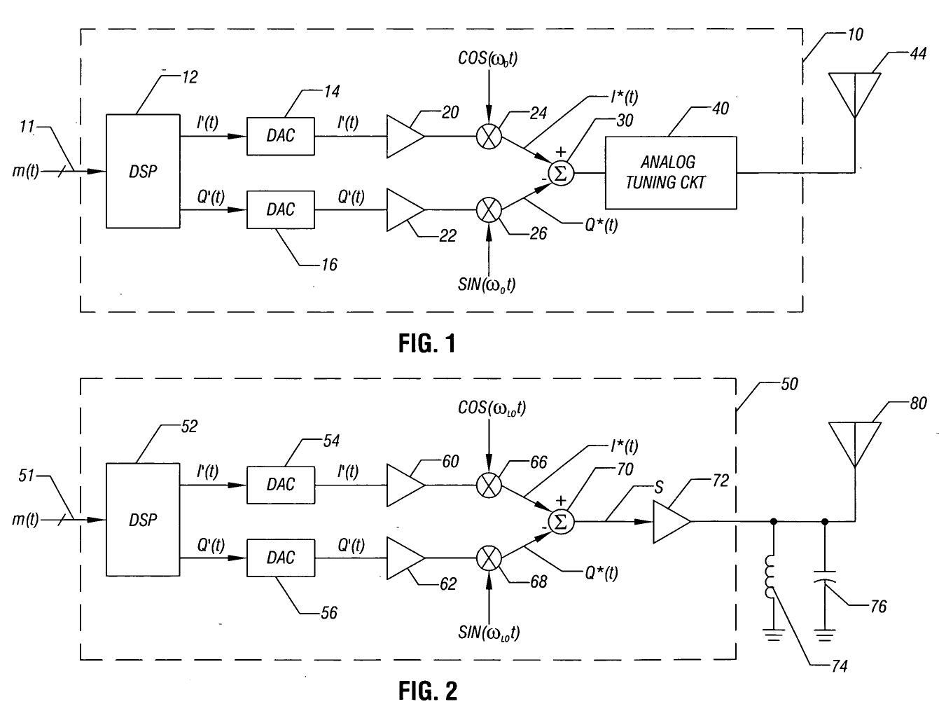

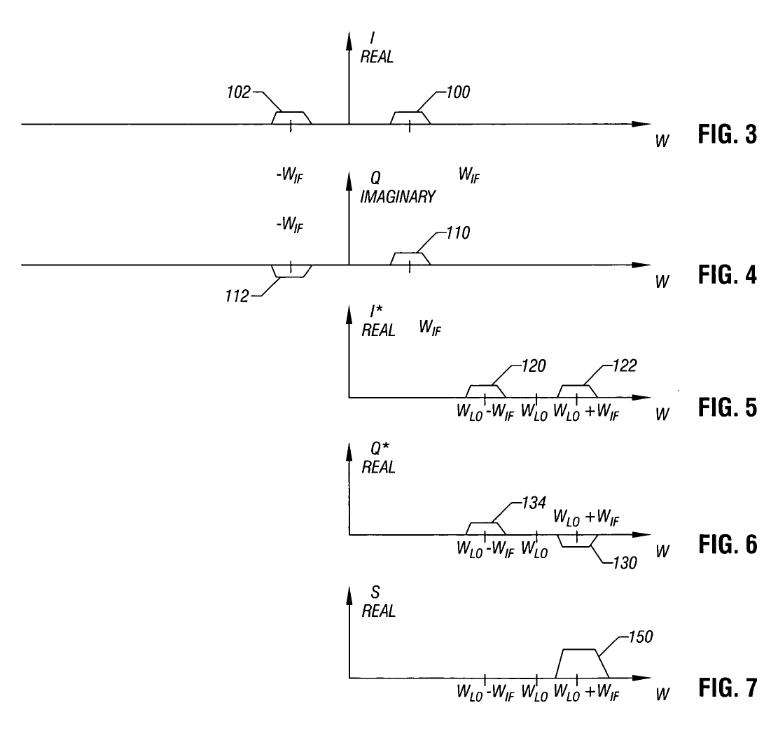

The above-described RF FM signal generation technique may be more fully appreciated by realizing that an FM signal may be alternatively represented (as compared to Eq. 1 above) as follows:
A_{c} cos(ω_{c}t)·cos(∫2πK_{f}m(t)dt)−A_{c} sin(ω_{c}t)·sin(∫2·K_{f}m(t)dt), Eq. 2
where “m(t)” is the message signal, “ω_{c}” is the radian carrier frequency “K_{f}” is the frequency gain and “A_{c}” is the amplitude of the FM signal. The components cos(∫2πK_{f}m(t)dt) and sin(∫2K_{f}m(t)dt) are effectively orthogonal FM signals that have zero carrier frequencies and may be realized in the digital domain. Thus, the cos(∫2πK_{f}m(t)dt) component may be viewed as being an in-phase FM signal (called “I(t)” in connection with FIG. 1 that is discussed below); and the sin(∫2πK_{f}m(t)dt) component may be viewed as being a quadrature FM signal (called “Q(t)” in connection with FIG. 1 that is discussed below). Referring to Eq. 2, the products of the I(t) and Q(t) orthogonal FM signals with the cosine (cos(ω_{c}t)) and sine (sin(ω_{c}t)) functions, respectively, frequency translate the I(t) and Q(t) signals into the RF range. This upconversion, or frequency translation, may be performed in the analog domain. The remaining function to produce the RF FM signal (see FIG. 2) is to mathematically combine the frequency translated signals together. Therefore, given the above-described analog and digital operations, an architecture that is similar to an upconversion transmitter 10 that is depicted in FIG. 1 may be used to generate an RF FM signal.

Referring to FIG. 1, the transmitter 10 includes a digital signal processor (DSP) 12 that receives the m(t) message signal at input terminals 11 and in response thereto produces digital orthogonal FM signals, which have zero carrier frequencies. More particularly, the DSP 12 produces an in-phase digital FM signal (called “I′(t)”) that has a zero carrier frequency and a quadrature digital FM signal (called “Q′(t)”) that has a zero carrier frequency. Digital-to-analog converters (DACs) 14 and 16 convert the I′(t) and Q′(t) digital signals into the I(t) and Q(t) analog signals, respectively.

The FM transmitter 10 includes analog mixers 24 and 26 that frequency translate the I(t) and Q(t) signals to the RF frequency range. In this regard, the mixer 24 multiplies the I(t) signal with an RF cosine signal (cos (ω_{c}t)) to produce a signal (called “I*(t)”) at its output terminal:
I*(t)=A_{c} cos(ω_{c}t)·cos(∫2πK_{f}m(t)dt). Eq. 3
The mixer 26 multiplies the Q(t) signal with an RF sine signal (sin (ω_{c}t)) to produce a signal (called “Q*(t)”) at its output terminal:
Q*(t)=A_{c}sin (ω_{c}t)·sin(∫2πK_{f}m(t)dt) Eq. 4
An adder 30 of the FM transmitter 10 mathematically combines the I*(t) and Q*(t) signals (subtracts the Q*(t) from the I*(t) signal, for example) to produce the RF FM signal (see Eq. 2 above) that may be furnished to an analog tuning circuit 40 (an LC tank, for example) and antenna 44.

Because the I(t) and Q(t) signals have spectral energy that is centered at DC, a potential challenge of using the transmitter 10 is that the spectral energy that is associated with DC offsets, local oscillator (LO) feedthrough and gain/phase errors in the LO path ends up in the RF channel frequency. For example, gain error (introduced by amplifiers 20 and 22, for example) may distort the m(t) signal (which becomes apparent when the RF FM signal is demodulated). Additionally, distortion may be introduced by quadrature and in-phase gain path differences and local oscillation path feedthrough.

In order to suppress these potential sources of distortion, DC offsets, local oscillator feedthrough, the gains of the in-phase and quadrature paths and the phases have to be calibrated, leading to increased complexity and increased silicon area. Furthermore, devices in the baseband signal path may have to be made relatively large in order to reduce flicker noise; and this may add costs in terms of silicon area.

Therefore, in accordance with some embodiments of the invention, an FM transmitter 50 that is depicted in FIG. 2 may be used in place of the FM transmitter 10. In contrast to the FM transmitter 10, the FM transmitter 50 digitally generates orthogonal intermediate frequency (IF) FM signals, instead of the zero carrier frequency orthogonal FM signals that are generated by the transmitter 10. In the context of this application, “IF” means a non-zero frequency less than the RF channel frequency of the generated RF FM signal. In some embodiments of the invention, IF means a frequency in the range of 100 KHz to 1 MHz, although other frequencies may be used for IF in other embodiments of the invention. It is noted that the IF frequency may be fixed or may vary according to the RF channel frequency to which the transmitter 50 is tuned, depending on the particular embodiment of the invention.

The FM transmitter 50 upconverts, or frequency translates, the orthogonal IF FM signals to the higher RF range before combining the translated signals to produce an RF FM signal. As described below, the digital generation of the orthogonal IF FM signal moves potentially distortion-introducing spectral energy away from the RF channel frequency.

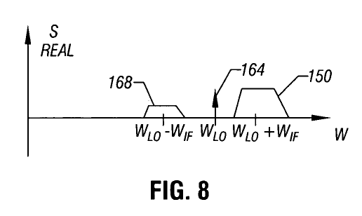

More specifically, the FM transmitter 50 includes a DSP 52 that receives an m(t) message signal at its input terminals 51 and generates digital orthogonal IF FM signals (called “I′(t)” and “Q′(t)”) in response thereto. DACs 54 and 56 convert the I′(t) and Q′(t) digital signals into analog signals called “I(t)” and “Q(t),” respectively, which are described below:
I(t)=cos(ω_{IF}t+∫2πK_{f}m(t)dt), and Eq. 5
Q(t)=sin(ω_{IF}t+∫2πK_{f}m(t)dt), Eq. 6
where “ω_{IF}” is the radian intermediate frequency about which the spectral energy of the I(t) and Q(t) signals are centered. More specifically, referring also to FIGS. 3 and 4, the I(t) signal contains spectral components 100 and 102 that are located at the positive and negative ω_{IF} radian frequencies, respectively; and the Q(t) signal contains imaginary spectral components 110 and 112 that are located at the positive and negative ω_{IF} radian frequencies, respectively. Comparing FIGS. 3 and 4, the spectral components 100 and 102 of the I(t) signal are positive; the positive frequency spectral component 110 of the Q(t) signal is positive; and the negative frequency spectral component 112 of the Q(t) signal is negative.

As depicted in FIG. 2, the I(t) and Q(t) signals pass through amplifiers 60 and 62, respectively, before being received at input terminals of upconverting, or frequency translating, mixers 66 and 68, respectively. The mixer 66 multiplies the amplified I(t) signal by a cosine wave signal (cos(ω_{LO}t)), whose fundamental frequency is a higher (relative to the intermediate frequency) local oscillator frequency (ω_{LO}) to produce a signal called I*(t) that is described below in Equation 7. Similarly, the Q(t) signal passes through the amplifier 62 to the input terminal of the mixer 68, which multiplies the amplified Q(t) signal by a sine wave signal (sin(ω_{LO}t) to produce a signal (called “Q*(t)”) that is described below in Equation 8:
I*(t)=cos(ω_{LO}t)·cos(ω_{IF}t+˜2πK_{f}m(t)dt) Eq. 7
Q*(t)=sin(•_{LO}t)·sin(ω_{IF}t+2πK_{f}m(t)dt) Eq. 8

In accordance with some embodiments of the invention, the ω_{LO} radian local oscillator frequency may be adjusted to tune the frequency of the RF FM signal that is produced by the transmitter to the appropriate channel.

Due to the frequency translation by the mixer 66, the spectral components 100 and 102 of the I(t) signal are shifted in frequency to produce the positive spectral components 122 and 120, respectively, of the I*(t) signal, as depicted in FIG. 5. As shown, the spectral components 120 and 122 are centered about the ω_{LO} radian frequency.

The mixer 68 frequency translates the Q(t) signal so that the Q*(t) signal has spectral components 130 and 134 that are located on the real axis and are centered at the ω_{LO} frequency. As shown in FIG. 6, the spectral component 130 is negative, and the spectral component 134 is positive.

An adder 70 of the FM transmitter 50 mathematically combines the Q*(t) and I*(t) signals to generate the RF FM signal (which is called “S(t)”) that propagates to an LC tank (i.e., a parallel-coupled inductor 74 and capacitor 76) to an antenna 80. In some embodiments of the invention, the adder 50 subtracts the Q*(t) signal from the I*(t) signal, thereby ideally canceling out the spectral components 120 and 134 and adding together the spectral components 122 and 130. Therefore, ideally, the S(t) signal contains a spectral component 150 that is centered at a radian frequency equal to the sum of the ω_{LO} and the ω_{IF} radian frequencies, as depicted in FIG. 7. Thus, the channel frequency is the sum of the ω_{IF} and ω_{LO} frequencies.

Due to such effects as mismatches in the amplitudes of the I*(t) and Q*(t) signals and phase mismatches, a non-ideal spectral component 168 appears at the ω_{LO}-ω_{IF} frequency, as depicted in FIG. 8. Furthermore, a spectral component 164 appears at the ω_{LO} frequency due to the DC offset in the baseband signal path and the local oscillator feedthrough. However, as can be seen from FIG. 8, the non-ideal effects such as the DC offset, local oscillator feedthrough, I/Q mismatches, etc., are pushed away from the RF channel frequency (ω_{LO}+ω_{IF}).

Therefore, because spectral energy due to DC offsets in the baseband path, local oscillator feedthrough and I/Q mismatches, etc. are pushed away from the RF transmit channel, spectral purity in the m(t) content is maintained. This leads to a relatively low audio distortion after FM demodulation in a receiver. Because FM modulation is performed in the digital domain, the maximum frequency deviation of the FM signal may be optimized. Furthermore, flicker noise in the baseband signal path is reduced as the signal is at the intermediate frequency. This leads to savings and die area.

Alternatively, the adder 70 may add the I*(t) and Q*(t) signals together to produce a signal having a spectral component at the ω_{LO}-ω_{IF} frequency (i.e., the RF channel frequency for this embodiment of the invention.) Thus, many variations are possible and are within the scope of the appended claims.

To summarize, in accordance with some embodiments of the invention, a technique 200 to generate an FM signal includes digitally generating (block 202) orthogonal FM signals that are centered at an intermediate frequency. These signals are frequency translated (block 206) at a higher local oscillation frequency. The frequency resultant translated signals are combined (block 210) to produce a substantially distortion-free RF FM signal.

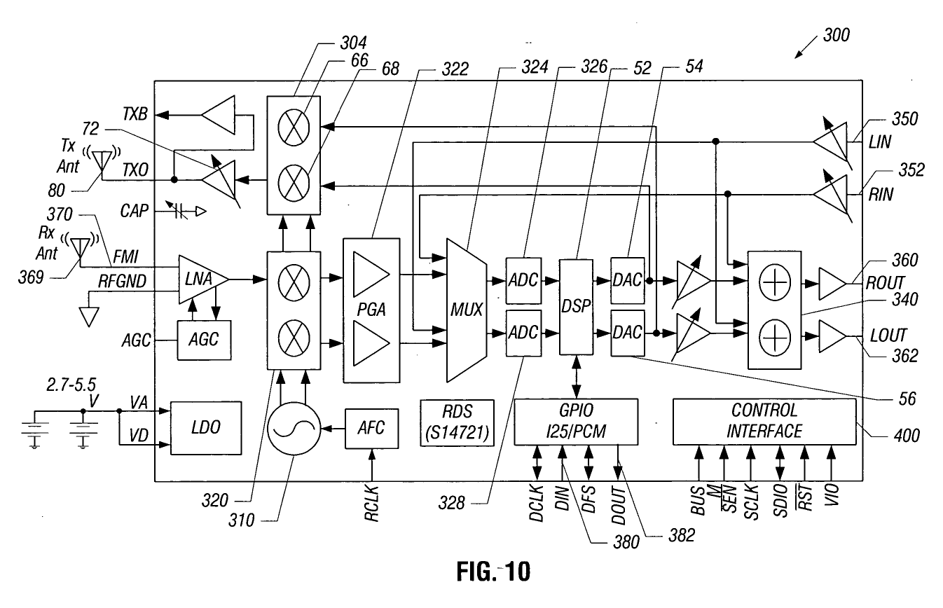

Referring to FIG. 10, in accordance with some embodiments of the invention, the FM transmitter 50 may be part of a multimode FM transceiver 300. More specifically, the multimode FM transceiver 300 includes the DSP 52 and DACs 54 and 56, as well as the mixers 66 and 68, which are part of a mixer circuit 304. Thus, as described above, the DSP 52 digitally generates the orthogonal IF FM signals, which are converted into the analog domain by the DACs 54 and 56 before being frequency translated into the RF range by the mixers 66 and 68. In accordance with some embodiments of the invention, the DSP 52 receives its audio signal via analog-to-digital converters (ADC) 326 and 328.

The FM transmitter is enabled during an FM transmit mode of the multimode FM transceiver 300. In addition to the FM transmit mode, in some embodiments of the invention, the multimode FM transceiver 300 has FM receive and audio modes, which all use the DSP 52, DACs 54 and 56 and ADCs 326 and 328 to perform FM transmit, FM receive, mixing, recording and audio codec functions, as further described in U.S. patent application Ser. No. ______, entitled, “MULTIMODE TRANSCEIVER,” which is filed concurrently herewith and is hereby incorporated by reference in its entirety.

In accordance with some embodiments of the invention, the multimode transceiver 300 may be fabricated on a monolithic semiconductor die. However, other embodiments are possible. Thus, in accordance with other embodiments of the invention, the multimode transceiver 300 may be formed on several interconnected semiconductor dies. In accordance with some embodiments of the invention, the multimode transceiver 300 may be part of a single semiconductor package, and in other embodiments of the invention, the multimode transceiver 300 may be formed from multiple semiconductor packages.

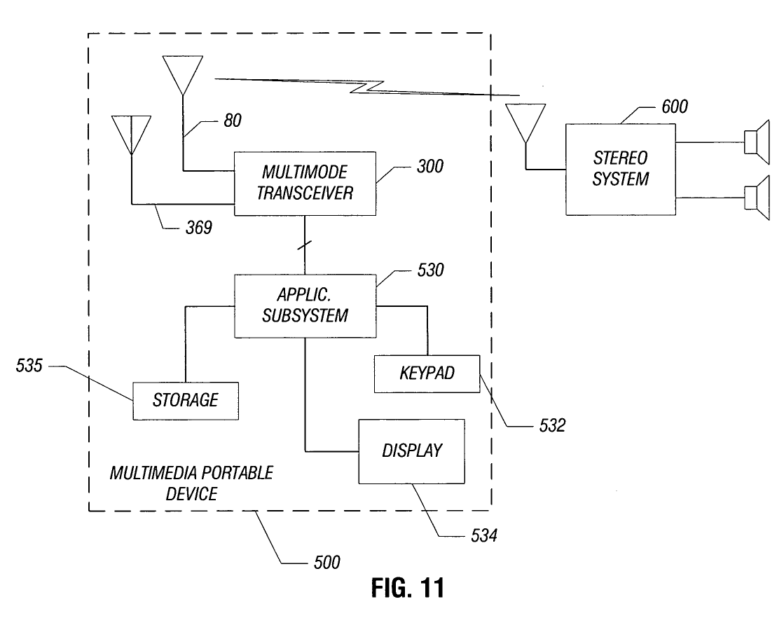

Referring to FIG. 11, in accordance with some embodiments of the invention, the multimode transceiver 300 may be part of a portable multimedia device 500 (an MP3 player or cellular telephone, as examples). The portable device 500 may store songs (in storage 535) and be capable of transmitting (via the multimode transceiver 300) an audio stream to a nearby FM receiver of a stereo system 600 for song playback. The signal that is communicated by the multimode transceiver 300 may be provided by an application subsystem 530. Furthermore, the application subsystem 530 as well as other subsystems of the transceiver 300 may use mixing and codec functions provided by the multimode transceiver 300. Additionally, the application subsystem 530 may receive input from a keypad 532 and may furnish signals to drive a display 534. It is noted that the multimedia portable device 500 is one out of many possible devices or systems that may incorporate the multimode transceiver 300, in accordance with the many possible embodiments of the invention.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
digitally generating orthogonal modulated signals, each of the orthogonal modulated signals having spectral energy being generally centered at an intermediate frequency;
frequency translating the orthogonal modulated signals to generate translated signals, each of the translated signals having spectral energy being generally centered at a second frequency higher than the intermediate frequency; and
combining the translated signals to generate a modulated signal.

2. The method of claim 1, wherein the digitally generally orthogonal signals comprise frequency modulated signals.

3. The method of claim 1, wherein the act of digitally generating comprises:
using a digital signal processor to generate the orthogonal frequency modulated signals.

4. The method of claim 1, wherein the act of digitally generating comprises:
digitally generating a cosine wave signal indicative of the modulation of a carrier signal having the intermediate frequency with an input signal; and
digitally generating a sine wave signal indicative of the modulation of the carrier signal with the input signal.

5. The method of claim 4, wherein translating comprises:
mixing the cosine wave signal with another cosine wave signal having the second frequency.

6. The method of claim 4, wherein translating comprises:
mixing the sine wave signal with another sine wave signal having the second frequency.

7. The method of claim 4, wherein the act of translating comprises mixing the cosine wave signal with another cosine wave signal having the second frequency to produce one of the translated signals, and mixing the sine wave signal with another sine wave signal having the second frequency to produce another one of the translated signals; and
wherein the combining comprises adding said one and said another one of the translated frequency signals together.

8. The method of claim 1, wherein the modulated signal generated by the combination has a carrier frequency approximately equal to the sum of the intermediate frequency and the second frequency.

9. The method of claim 1, wherein the modulated signal generated by the combination comprises a frequency modulated signal.

10. A transmitter comprising:
a digital signal processor to digitally generate orthogonal modulated signals, each of the orthogonal modulated signals having spectral energy being generally centered at an intermediate frequency;
mixers to frequency translate of the orthogonal signals to generate translated signals, each of the translated signals having spectral energy generally centered at a second frequency higher than the intermediate frequency; and
an adder to combine the translated signals to generate a modulated signal.

11. The transmitter of claim 10, wherein the digitally generated orthogonal signals comprise frequency modulated signals.

12. The transmitter of claim 10, further comprising:
analog to digital converters to convert the orthogonal modulated signals from digital to analog signals.

13. The transmitter of claim 10, wherein the digital signal processor is adapted to:
digitally generate a cosine wave signal indicative of the modulation of a carrier signal having the intermediate frequency with an input signal; and
digitally generate a sine wave signal indicative of the modulation of the carrier signal with the input signal.

14. The transmitter of claim 13, wherein one of the mixers is adapted to mix the cosine wave signal with another cosine wave signal having the second frequency.

15. The transmitter of claim 13, wherein one of the mixers is adapted to mix the sine wave signal with another sine wave signal having the second frequency.

16. The transmitter of claim 10, wherein the modulated signal generated by the combination comprises a signal having a carrier frequency approximately equal to the sum of the intermediate frequency and the second frequency.

17. The transmitter of claim 10, wherein the modulated signal generated by the combination comprises a frequency modulated signal.

18. A method comprising:
digitally generating at least one intermediate frequency, modulated signal; and
converting said at least one intermediate frequency, modulated signal to a higher frequency.

19. The method of claim 18, wherein the digitally generated orthogonal signals comprise frequency modulated signals.

20. The method of claim 18, wherein the act of converting comprises:
routing said at least one intermediate, modulated signal through at least one analog mixer.

21. The method of claim 18, wherein the act of converting comprises:
translating said at least one intermediate, modulated signal to a radio frequency range.

22. A transmitter comprising:
a processor to digitally generate at least one intermediate frequency, modulated signal; and
an upconverter to convert said at least one intermediate frequency, modulated signal to a higher frequency.

23. The transmitter of claim 22, wherein the upconverter comprises at least one analog mixer.

24. The transmitter of claim 22, wherein the higher frequency comprises a frequency in a radio frequency range.

25. The transmitter of claim 22, wherein the digitally generated orthogonal signals comprise frequency modulated signals.
